(19) United States
(12) Patent Application Publication
(10) Pub. No.: US 2016/0334286 A1
(43) Pub. Date: Nov. 17, 2016

(54) Ultrasonic Integrating Calorimeter

(71) Applicant: Azbil Corporation, Tokyo (JP)

(72) Inventor: Hidekazu TANAKA, Tokyo (JP)

(73) Assignee: Azbil Corporation, Tokyo (JP)

(21) Appl. No.: 15/132,607

(22) Filed: Apr. 19, 2016

(30) Foreign Application Priority Data
Apr. 28, 2015 (JP) 2015-091787

(51) Int. Cl. G01K 17/16; G01F 1/66

(52) U.S. Cl. CPC G01K 17/16; G01F 1/66

(57) ABSTRACT

An ultrasonic integrating calorimeter having a supply side temperature detector; a return side temperature detector; a flow rate measure provided with a flow rate measuring pipe wherein a return side fluid flows in a heat exchanging circuit, a first and second ultrasonic transducer; a calorific value calculator, secured to the flow rate measuring portion, calculating the calorific value of the heat exchanged by the heat exchanging circuit, from the outputs of the supply side temperature detector, the return side temperature detector, and the flow rate measuring portion. A calculation signal line transmits, from the flow rate measuring portion to the calorific value calculator, an output signal of the flow rate measuring portion. A display, which can be separate from the calorific value calculator, displays a calorific value; and a display signal line transmits an output of the calorific value calculator from the calorific value calculator to the display.

### CROSS-REFERENCE TO RELATED APPLICATION

This application claims priority to Japanese Application No. 2015-091787 filed Apr. 28, 2015. This application is incorporated herein in its entirety.

### FIELD OF TECHNOLOGY

The present invention relates to a fluid measuring technology, and, in particular, relates to an ultrasonic integrating calorimeter.

### BACKGROUND

An integrating calorimeter calculates the calorific value of heat exchange by a heat exchanger by measuring a flow rate of a fluid that passes through the heat exchanger, the temperature of the fluid on the supply side of the heat exchanger, and the temperature of the fluid on the return side of the heat exchanger (referencing, for example, Japanese Unexamined Patent Application Publication No. 2013-178127). Specifically, an integrating calorimeter measures the calorific value of the heat exchanged by a heat exchanger by multiplying the flow rate of the fluid that passes through the heat exchanger, the temperature difference of the fluid between the supply side and the return side of the heat exchanger, and a calorific value conversion coefficient. In the integrating calorimeter, an ultrasonic flow meter may be used for measuring the flow rate of the fluid. An ultrasonic flow meter is provided with ultrasonic transducers that are provided in the pipes on the upstream side and downstream side. In the ultrasonic flow meter, ultrasound is transmitted toward the fluid that is flowing in the pipe, and the flow speed or flow rate of the fluid flowing within the pipe is calculated based on a time difference between the propagation time for the ultrasound that propagates in the fluid from the upstream side toward the downstream direction, and the propagation time for the ultrasound propagates in the other direction, from the downstream side toward the upstream direction (referencing, for example, Japanese Unexamined Patent Application Publication Nos. 2004-520573 (JP '573) and 2013-88322 (JP '322)). JP '322 discloses a correlation method and a zero-cross method, and the like, as methods for calculating flow speeds and flow rates.

### SUMMARY OF THE INVENTION

One object of the present invention is to provide an ultrasonic integrating calorimeter with high accuracy.

An aspect of the present invention provides ultrasonic integrating calorimeter including (a) a supply side temperature detector for detecting a supply side temperature of a fluid on a supply side of a heat exchanging circuit; (b) a return side temperature detector for detecting a return side temperature of the fluid on a return side of the heat exchanging circuit; (c) a flow rate measuring portion comprising a flow rate measuring pipe portion wherein flows a fluid of the return side of the heat exchanging circuit, a first ultrasonic transducer for injecting a first ultrasonic signal into the flow rate measuring pipe portion, and a second ultrasonic transducer, disposed at a position able to receive the first ultrasonic signal, for injecting a second ultrasonic signal into the flow rate measuring pipe portion; (d) a calorific value calculator, secured to the flow rate measuring portion, for calculating a calorific value for the heat exchanged by the heat exchanging circuit, based on outputs of the supply side temperature detector, the return side temperature detector, and the flow rate measuring portion; (e) a calculation signal line for transmitting, from the flow rate measuring portion to the calorific value calculator, an output signal of the flow rate measuring portion; (f) a displaying portion, which may be separated from the calorific value calculator, for displaying the calorific value; and (g) a display signal line for transmitting, from the calorific value calculator to the displaying portion, an output signal of the calorific value calculator; wherein: (h) the calculation signal line is shorter than the display signal line.

Having the calorific value calculator be secured to the flow rate measuring portion, and having the calculation signal line be shorter than the display signal line, in the ultrasonic integrating calorimeter according to this aspect of the present invention, reduces the susceptibility to the effects of noise, enabling a high-precision measurement of the integrated calorific value.

In the ultrasonic integrating calorimeter described above, the calorific value calculator may be secured to the flow rate measuring pipe portion.

The ultrasonic integrating calorimeter described above may further have a dummy signal transmitting portion, secured to the flow rate measuring portion, for transmitting a dummy signal for the calorific value to the displaying portion, wherein the display signal line may connect the calorific value calculator and the dummy signal transmitting portion to the displaying portion. Moreover, the dummy signal transmitting portion may generate the dummy signal independently from the calorific value calculator.

The ultrasonic integrating calorimeter described above may further include a testing portion for displaying the dummy signal on the displaying portion, to test whether or not the dummy signal displayed on the displaying portion is affected by noise, when the calorific value displayed on the displaying portion is affected by noise. Here the testing portion may determine that the display signal line is affected by noise if the dummy signal, displayed on the displaying portion, is affected by noise. Moreover, the testing portion may determine that the flow rate measuring portion is affected by noise if the dummy signal, displayed on the displaying portion, is not affected by noise. Conversely, the testing portion may determine that the calorific value calculator is affected by noise if the dummy signal, displayed on the displaying portion, is not affected by noise. Moreover, conversely, the testing portion may determine that the calculation signal line is affected by noise if the dummy signal, displayed on the displaying portion, is not affected by noise.

In the ultrasonic integrating calorimeter described above the fluid flow rate may be measured based on a time difference between a first time, for the first ultrasonic signal to arrive at the second ultrasonic transducer through the interior of the measuring pipe, and a second time, for the second ultrasonic signal to arrive at the first ultrasonic transducer through the interior of the measuring pipe, and the return side temperature. Moreover, the return side temperature may be used in correcting the fluid flow rate that is calculated based on the first time and the second time.

In the ultrasonic integrating calorimeter described above, the flow rate measuring portion may be disposed in a space over a ceiling and the displaying portion may be disposed within a room. Moreover, the heat exchanging circuit may be included in a fan coil unit.

In the ultrasonic integrating calorimeter described above, the return side temperature detector may detect a return side temperature of the fluid within the flow rate measuring pipe portion. Conversely, the return side temperature detector may detect a return side temperature of a fluid within a return pipe connected to the flow rate measuring pipe portion.

The present invention can provide a high-accuracy ultrasonic integrating calorimeter.

### BRIEF DESCRIPTION OF THE DRAWINGS

FIG. 1 is a schematic diagram of an ultrasonic integrating calorimeter according to a first example according to the present invention.

FIG. 2 is a schematic cross-sectional view of a flow rate measuring portion relating to an example according to the present invention.

FIG. 3 is a schematic cross-sectional view of a flow rate measuring portion relating to the example according to the present invention.

FIG. 4 is a schematic cross-sectional view of a flow rate measuring portion relating to the example according to the present invention.

FIG. 5 is a schematic diagram of an ultrasonic integrating calorimeter according to another example according to the present invention.

FIG. 6 is a schematic diagram of an ultrasonic integrating calorimeter according to a further example according to the present invention.

FIG. 7 is a schematic diagram of an ultrasonic integrating calorimeter according to the further example according to the present invention.

### DETAILED DESCRIPTION

Examples of the present invention will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

### An Example

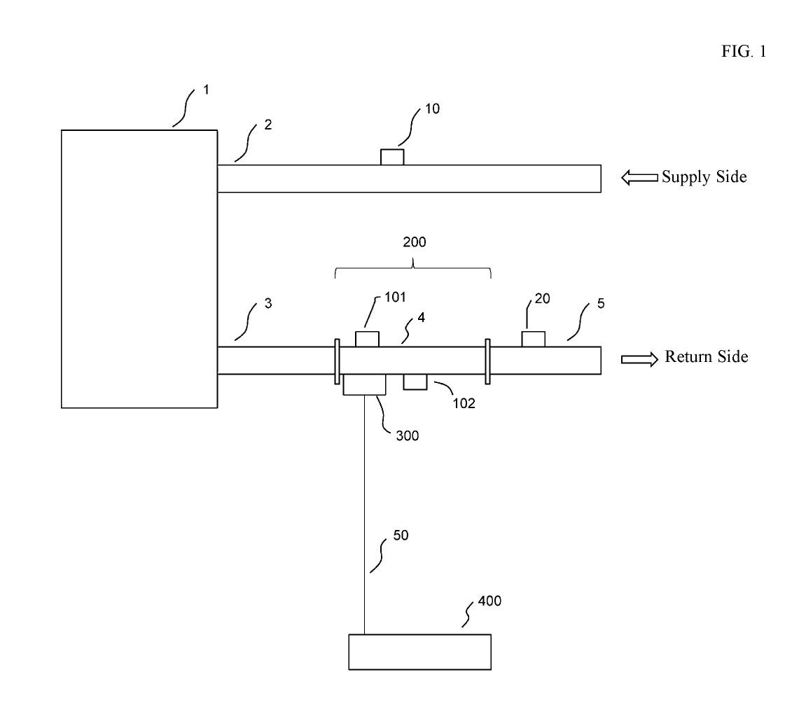

As illustrated in FIG. 1, an ultrasonic integrating calorimeter according to an example includes a supply side temperature detector 10, a return side temperature detector 20, and a flow rate measuring portion 200. The supply side temperature detector 10 detects a supply side temperature for the fluid on the supply side of a heat exchanging circuit 1. The return side temperature detector 20 detects a return side temperature of the fluid on the return side of the heat exchanging circuit 1. The flow rate measuring portion 200 has a flow rate measuring pipe portion 4 wherein fluid flows on the return side of the heat exchanging circuit 1, a first ultrasonic transducer 101 for injecting a first ultrasonic signal for the first flow rate measuring pipe portion 4, and a second ultrasonic transducer 102 for injecting a second ultrasonic signal for the flow rate measuring pipe portion 4, disposed at a position able to receive the first ultrasonic signal.

The ultrasonic integrating calorimeter according to this example further includes a calorific value calculator 300 and a calculation signal line. The calorific value calculator 300 calculates the calorific value for the heat exchanged by the heat exchanging circuit 1 based on the outputs of the supply side temperature detector 10, the return side temperature detector 20, and the flow rate measuring portion 200. The calorific value calculator 300 is secured to the flow rate measuring portion 200. The calculation signal line transmits the output signal of the flow rate measuring portion 200 from the flow rate measuring portion 200 to the calorific value calculator 300.

The ultrasonic integrating calorimeter according to the example further has a displaying portion 400 and a display signal line 50. The displaying portion 400 displays the calorific value, and may be separate from the calorific value calculator 300. The display signal line 50 transmits the output signal of the calorific value calculator 300 from the calorific value calculator 300 to the displaying portion 400. In the ultrasonic integrating calorimeter according to the example, the calculation signal line is shorter than the display signal line 50.

The heat exchanging circuit 1 is included in, for example, a fan coil unit. A supply pipe 2, wherein flows a fluid that is a thermal medium that flows within the heat exchanging circuit 1, is connected to the supply side of the heat exchanging circuit 1. Here the fluid may be a gas or a liquid. The supply side temperature detector 10 is provided in or on the supply pipe 2. The supply side temperature detector 10 is, for example, equipped with a platinum temperature measuring resistance, protected by a stainless steel protective tube, inserted into the supply pipe 2. In the heat exchanging circuit 1, the fluid that flows in from the supply pipe 2 releases or absorbs heat.

A return pipe 3, wherein flows the fluid that flows out of the heat exchanging circuit 1, is connected to the return side of the heat exchanging circuit 1. The flow rate measuring pipe portion 4 of the flow rate measuring portion 200 is connected between the return pipe 3 and a return pipe 5. The fluid that flows out from the heat exchanging circuit 1 flows through the return pipe 3, the flow rate measuring pipe portion 4, and the return pipe 5. The return side temperature detector 20 is equipped with, for example, a platinum temperature measuring resistance that is protected by a stainless steel protective tube, inserted in the return pipe 5. Note that the return side temperature detector 20 may be provided within the return pipe 3 instead.

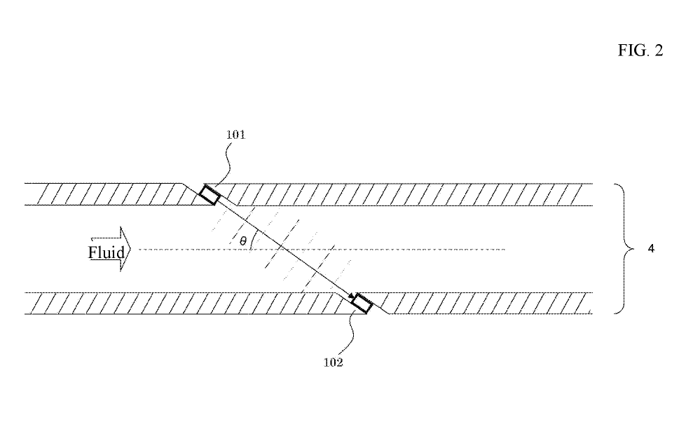

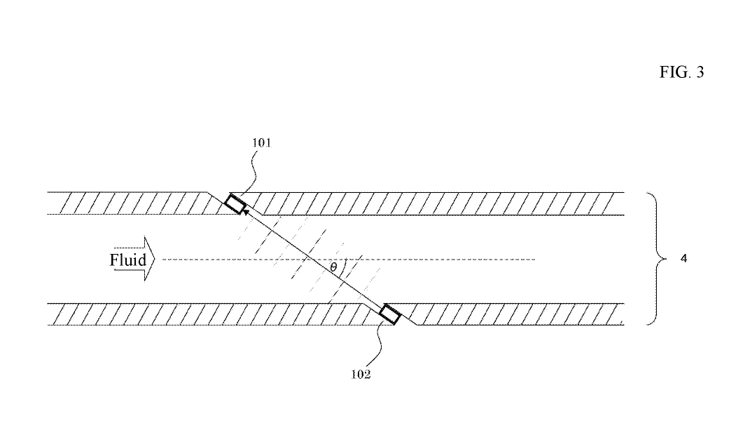

The first ultrasonic transducer 101 and the second ultrasonic transducer 102 are provided in the flow rate measuring pipe portion 4. As illustrated in FIG. 2, the first ultrasonic transducer 101 is disposed on the upstream side of the fluid that flows within that the flow rate measuring pipe portion 4, and the second ultrasonic transducer 102 is disposed on the downstream side. A first ultrasonic signal, emitted by the first ultrasonic transducer 101 advances within the fluid within the flow rate measuring pipe portion 4, to be received by the second ultrasonic transducer 102. As illustrated in FIG. 3, a second ultrasonic signal, emitted by the second ultrasonic transducer 102, advances within the fluid within the flow rate measuring pipe portion 4, to be received by the first ultrasonic transducer 101. Driving signals are applied, for example, alternatingly to the first ultrasonic transducer 101 and the second ultrasonic transducer 102, to emit ultrasonic signals alternatingly.

A fluid flows with a flow speed v within the flow rate measuring pipe portion 4. As described above, the first ultrasonic transducer 101 is disposed on the upstream side of the fluid that flows in the flow rate measuring pipe portion 4, and the second ultrasonic transducer 102 is disposed on the downstream side. Because of this, the first ultrasonic signal, which is emitted by the first ultrasonic transducer 101, illustrated in FIG. 2, propagates along the flow of the fluid within the hollow trunk portion within the flow rate measuring pipe portion 4. In contrast, the second ultrasonic signal, which is emitted by the second ultrasonic transducer 102, illustrated in FIG. 3, propagates in the opposite direction of the flow of the fluid through the hollow trunk portion within the flow rate measuring pipe portion 4. As a result, a difference is produced between the propagation time for the first ultrasonic signal and the propagation time for the second ultrasonic signal, depending on the flow speed v of the fluid within the hollow trunk portion within the flow rate measuring pipe portion 4.

When the angle of the direction in which the first ultrasonic signal advances, in relation to the angle with which the fluid advances within the flow rate measuring pipe portion 4, illustrated in FIG. 2, is defined as θ, and the speed of sound for the ultrasound in the fluid within the flow rate measuring pipe portion 4 is defined as c, then the propagation time t₁ required for the first ultrasonic signal to traverse the hollow trunk portion of the flow rate measuring pipe portion 4 is given by the following Equation (1):

t₁=L/(c+v·cos θ) (1)

Moreover, when the angle of the direction in which the second ultrasonic signal advances, in relation to the angle with which the fluid advances within the flow rate measuring pipe portion 4, illustrated in FIG. 3, is also defined as θ, then the propagation time t₂ required for the second ultrasonic signal to traverse the hollow trunk portion of the flow rate measuring pipe portion 4 is given by the following Equation (2):

t₂=L/(c−v·cos θ) (2)

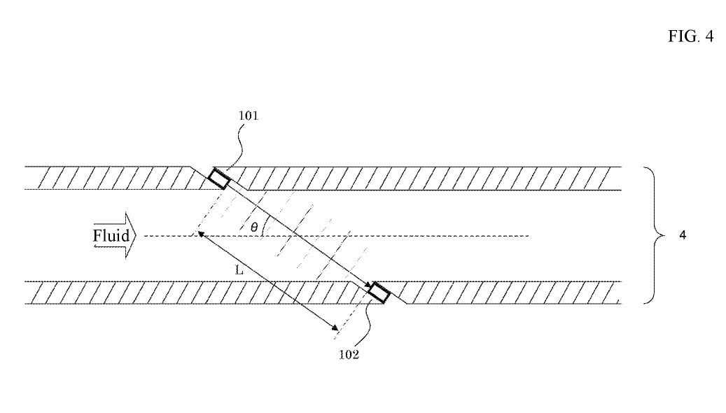

Here, as illustrated in FIG. 4, L indicates the length over which the first ultrasonic signal and the second ultrasonic signal traverse the hollow trunk portion within the flow rate measuring pipe portion 4.

From Equations (1) and (2), above, the sum of the inverse of the propagation time t₁ and the inverse of the propagation time t₂ is given by Equation (3), below:

$$\begin{matrix}1 / {t}_{1} + 1 / {t}_{2} = ( c + v \cdot cos θ ) / L + ( c - v \cdot cos θ ) / L \\ = 2 c / L\end{matrix} \qquad ( 3 )$$

From Equation (3), above, the speed of sound c in the fluid that flows within the hollow trunk portion of the flow rate measuring pipe portion 4 is given by Equation (4), below:

c=L(1/t₁+1/t₂)/2 (4)

Moreover, the difference Δt between the propagation time t₂ and the propagation time t₁, from Equations (1) and (2), above, is given by Equation (5), below:

Δt=t₂−t₁≈(2Lv·cos θ)/c2 (5)

From Equation (5), above, the flow speed v of the fluid that flows in the hollow trunk portion within the flow rate measuring pipe portion 4 is given by Equation (6), below:

v=c2Δt/(2L·cos θ) (6)

Here the speed of sound c can be calculated by Equation (4), above. The angle θ and the length L are known. Consequently, through measuring the time difference Δt between the propagation times t₁ and t₂ for the first and second ultrasonic signals enables calculation of the flow speed v of the fluid that flows within the hollow trunk portion within the flow rate measuring pipe portion 4.

The time difference Δt between the propagation times t₁ and t₂ of the first and second ultrasonic signals may be calculated through a correlation method. In this case, a cross-correlation function between the overall waveform of the signal received for the first ultrasonic signal and the overall waveform of the signal received for the second ultrasonic signals may be calculated, and the time difference Δt between the propagation times t₁ and t₂ of the first and second ultrasonic signals may be calculated from the peak of the cross-correlation function that has been calculated.

Moreover, the flow rate Q of the fluid can be calculated by multiplying the flow speed v of the fluid by the cross-sectional area S of the flow rate measuring pipe portion 4, as shown in Equation (7), below:

Q=S·v (7)

The calorific value calculator 300, illustrated in FIG. 1, may be secured to the flow rate measuring pipe portion 4. The calorific value calculator 300 monitors, through the calculation signal line, the timing with which the first ultrasonic transducer 101 emits the first ultrasonic signal and the timing with which the second ultrasonic transducer 102 receives the first ultrasonic signal, to measure the first propagation time t₁ from the emission of the first ultrasonic signal by the first ultrasonic transducer 101 until the arrival thereof at the second ultrasonic transducer 102, passing through the flow rate measuring pipe portion 4.

Here the timing with which the first ultrasonic signal is emitted from the first ultrasonic transducer 101 may be defined as the timing with which the first ultrasonic transducer 101 is driven. Moreover, when the strength of the signal received by the second ultrasonic transducer 102 at the timing with which the first ultrasonic signal arrives at the second ultrasonic transducer 102 is weak, the timing of arrival of the first ultrasonic signal at the second ultrasonic transducer 102 may be back-calculated from the timing at which a feature point is produced in the waveform of the received signal. The feature point of the received signal may be, for example, the point at which the strength of the received signal goes to zero after a prescribed number of maxima in the amplitude waveform of the received signal (the zero-cross point).

In addition, the calorific value calculator 300 monitors, through the calculation signal line, the time at which the second ultrasonic transducer 102 emits the second ultrasonic signal and the time at which the first ultrasonic transducer 101 receives the second ultrasonic signal, to measure the second propagation time t₂ with which the second ultrasonic signal passes through the interior of the flow rate measuring pipe portion 4 to arrive at the first ultrasonic transducer 101 after emission from the second ultrasonic transducer 102.

Here the timing with which the second ultrasonic signal is emitted from the second ultrasonic transducer 102 may be defined as the timing with which the second ultrasonic transducer 102 is driven. Moreover, when the strength of the signal received by the first ultrasonic transducer 101 at the timing with which the second ultrasonic signal arrives at the first ultrasonic transducer 101 is weak, the timing of arrival of the second ultrasonic signal at the first ultrasonic transducer 101 may be back-calculated from the timing at which a feature point (for example, the zero-cross point) is produced in the waveform of the received signal.

The calorific value calculator 300 calculates the speed of sound c in the fluid that flows through the hollow trunk portion within the flow rate measuring pipe portion 4 using Equation (4), above, based on the measured first and second propagation times t₁ and t₂. Moreover, the calorific value calculator 300 calculates the flow speed v of the fluid that flows through the hollow trunk portion within the flow rate measuring pipe portion 4, based on Equation (6), above, based on the measured first and second propagation times t₁ and t₂ and the calculated speed of sound c, and then, through Equation (7), above, calculates the flow rate Q of the fluid. Note that, as described above, the time difference Δt between the propagation times t₁ and t₂ of the first and second ultrasonic signals may be calculated directly through a correlation method.

The flow speed v of the fluid, calculated through Equation (6), above, is the average flow speed of the fluid in the path over which the ultrasound propagates. However, preferably the flow rate Q of the fluid is calculated based on the average flow speed of the fluid in the cross-section of the flow rate measuring pipe portion 4. Because of this, the calorific value calculator 300 corrects, through the method described below, the flow rate Q of the fluid calculated by Equations (6) and (7).

The calorific value calculator 300 receives, through the calculation signal line, the return side temperature within the flow rate measuring pipe portion 4, detected by the return side temperature detector 20. The calorific value calculator 300 specifies a value for the dynamic viscosity γ of the fluid based on the value of the return side temperature of the fluid received, and on the relationship between the temperature and the dynamic viscosity, prepared in advance. The relationship between the temperature and the dynamic viscosity is stored in, for example, a storing device. Moreover, the calorific value calculator 300 calculates the Reynolds number of Re of the fluid using Equation (8), below:

Re=V·L/γ (8)

The calorific value calculator 300 specifies the value for a flow rate correcting coefficient k based on the value calculated for the Reynolds number Re and a relationship between the Reynolds number Re and the flow rate correction coefficient, prepared in advance. The relationship between the Reynolds number Re and the flow rate correction coefficient k is, for example, stored in a storing device. The calorific value calculator 300 calculates the corrected flow rate QC for the fluid by dividing the flow rate Q of the fluid, calculated using Equation (7), above, by the flow rate correction coefficient k, as indicated in Equation (9), below. Through this, the effects of the characteristics wherein the speed of sound varies depending on the dynamic viscosity of the fluid are corrected.

QC=Q/k (9)

Moreover, the calorific value calculator 300 calculates the calorific value of the heat exchanged in the heat exchanging circuit 1 based on the corrected flow rate QC for the fluid, the supply side temperature of the fluid that is detected by the supply side temperature detector 10, and the return side temperature of the fluid, detected by the return side temperature detector 20. The calorific value calculator 300 outputs, through the display signal line 50, to the displaying portion 400, an output signal for the calorific value that is calculated. A liquid crystal display, a segment display, or the like, may be used for the displaying portion 400. The displaying portion 400 may be separate from the flow rate measuring portion 200 and the calorific value calculator 300, where, for example, the flow rate measuring portion 200 may be disposed in a space over the ceiling, and the displaying portion 400 may be disposed within the room. The display signal line 50 that connects between the calorific value calculator 300 and the displaying portion 400 has a length that enables the displaying portion 400 to be disposed in an arbitrary location.

In a conventional ultrasonic integrating calorimeter, the flow rate measuring portion is disposed in a space over the ceiling, for example, and the calculator and displaying portion are disposed together within the room. However, in a conventional ultrasonic integrating calorimeter, the integrated calorific value cannot be measured accurately, and the present inventor, at the conclusion of diligent research, discovered that because the signal line that connects the flow rate measuring portion and the calculator is long, there is a tendency for there to be noise, such as power supply noise, on the signal line, making it difficult to separate the high-frequency noise from the ultrasonic signal.

In contrast, in the ultrasonic integrating calorimeter according to the first example, the calorific value calculator 300 is secured to the flow rate measuring portion 200, the calculation signal line between the calorific value calculator 300 and the flow rate measuring portion 200, which is equipped with the first and second ultrasonic transducers 101 and 102, is short, reducing the effect of noise. Because of this, this enables a highly accurate integrating calorific value measurement.

### Another Example

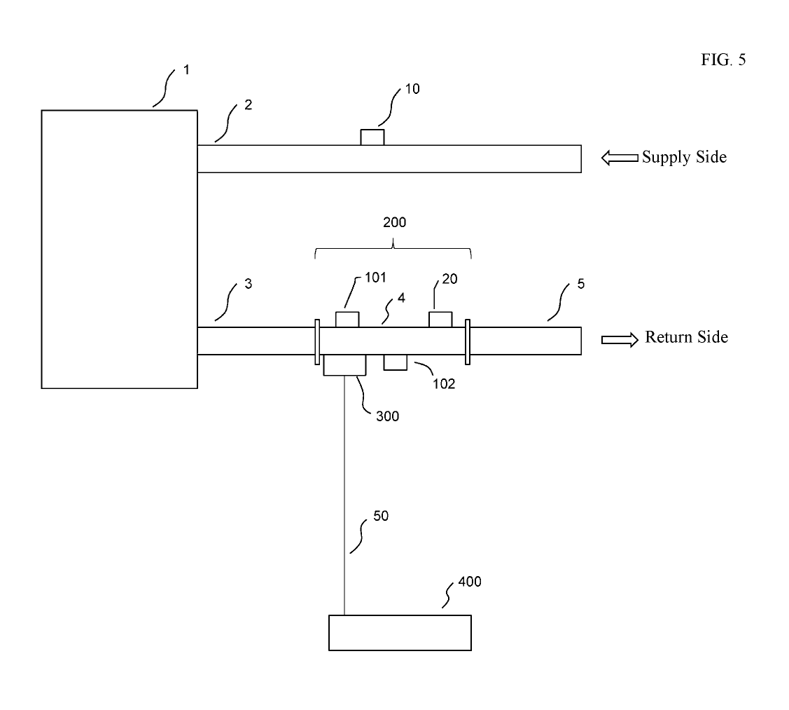

The above example explained an example wherein a return side temperature detector 20 detects a return side temperature of the fluid within the return pipe 5 that is connected to the flow rate measuring pipe portion 4, as illustrated in FIG. 1. In contrast, the return side temperature detector 20 may be provided in the flow rate measuring pipe portion 4, to detect the return side temperature of the fluid in the flow rate measuring pipe portion 4, as illustrated in FIG. 5.

If the return side temperature detector 20 is secured to the flow rate measuring pipe portion 4 in advance, before shipping, this can reduce the risk of incorrectly switching the supply side temperature detector 10 and the return side temperature detector 20. Moreover, providing the return side temperature detector 20 in the flow rate measuring pipe portion 4 enables the signal line that connects the return side temperature detector 20 and the calorific value calculator 300 to be shorter than if the return side temperature detector 20 were provided in the return pipe 5, thus making it possible to reduce the cost of the signal line.

### Further Example

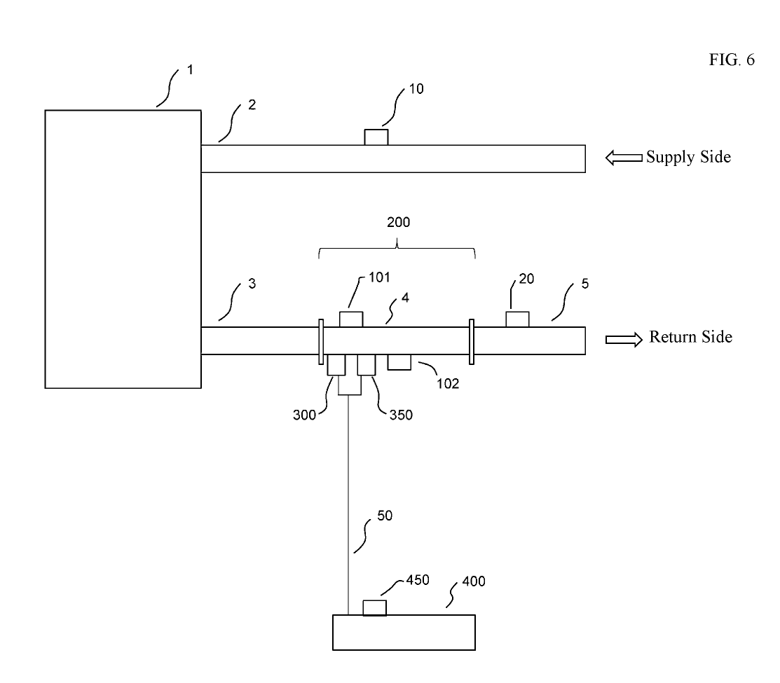

As illustrated in FIG. 6, an ultrasonic integrating calorimeter according to a further example further comprises a dummy signal transmitting portion 350, secured to the flow rate measuring portion 200, for sending a dummy signal for the calorific value to the displaying portion 400. In this example, the display signal line 50 connects the calorific value calculator 300 and the dummy signal transmitting portion 350 to the displaying portion 400. The dummy signal transmitting portion 350 generates a dummy signal for the calorific value, independent of the calorific value calculator 300, and transmits it to the displaying portion 400 through the display signal line 50. Note that the dummy signal transmitting portion 350 and the calorific value calculator 300 may be embodied in an integrated electronic circuit board.

The ultrasonic integrating calorimeter according to this example further includes a testing portion 450. The testing portion 450 displays, on the displaying portion 400, the dummy signal transmitted from the dummy signal transmitting portion 350, to test whether or not to the dummy signal, displayed on the displaying portion 400, has been affected by noise, when the calorific value, calculated by the calorific value calculator 300, displayed on the displaying portion 400, has been affected by noise.

If the dummy signal that is displayed on the displaying portion 400 is affected by noise, then the testing portion 450 will determine that the display signal line 50 has been affected by noise. If the dummy signal displayed on the displaying portion 400 is not affected by noise, then the testing portion 450 determines that either the flow rate measuring portion 200, the calorific value calculator 300, or the calculation signal line has been affected by noise.

Given the ultrasonic integrating calorimeter according to this example, when there is a noise effect, the part that is affected by noise can be identified. The other structural elements in the ultrasonic integrating calorimeter according to this example are identical to those in the above example.

### Yet Further Example

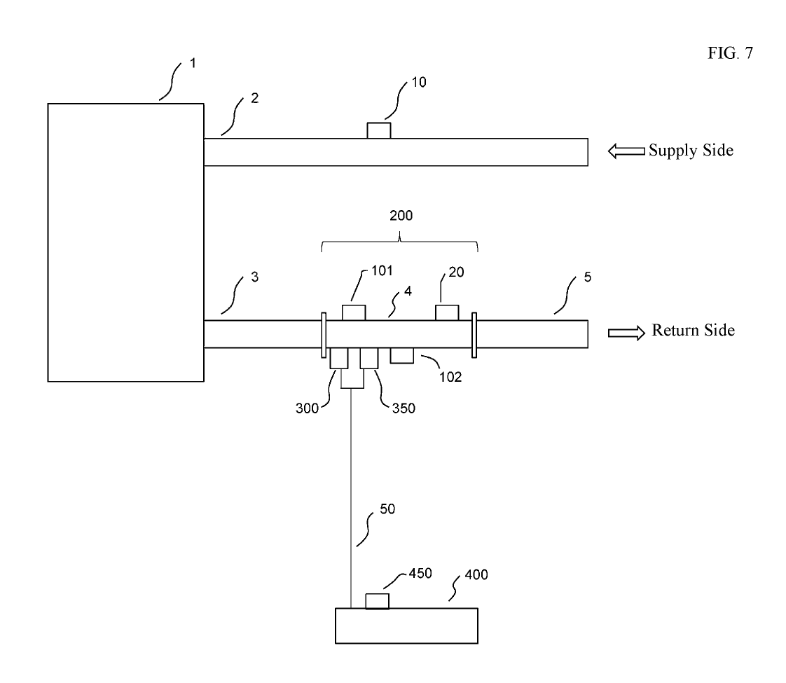

The above example explained an example wherein a return side temperature detector 20 detects the return side temperature of the fluid within the return pipe 5, which is connected to the flow rate measuring pipe portion 4, as illustrated in FIG. 6. In contrast, the return side temperature detector 20 may be provided in the flow rate measuring pipe portion 4, to detect the return side temperature of the fluid in the flow rate measuring pipe portion 4, as illustrated in FIG. 7.

When there is a noise effect, the part that is affected by noise can be identified by the ultrasonic integrating calorimeter according to the fourth example as well. The other structural elements in the ultrasonic integrating calorimeter according to this example are identical to those in the above example.

### Other Examples

While there are descriptions of examples as set forth above, the descriptions and drawings that form a portion of the disclosure are not to be understood to limit the present disclosure. A variety of alternate examples of example and operating technologies should be obvious to those skilled in the art. For example, examples wherein the first and second ultrasonic transducers 101 and 102 are disposed facing each other were illustrated in FIG. 1 through FIG. 6. In contrast, if the ultrasonic signal is reflected within the flow rate measuring pipe portion 4, the first and second ultrasonic transducers 101 and 102 need not necessarily be disposed facing each other.

Moreover, the flow speed v of the fluid that flows through the hollow trunk portion of the flow rate measuring pipe portion 4 may be calculated through a propagation time inverse-difference method:

v=(L/2 cos θ){(1/t₁)−(1/t₂)} (10)

Given the propagation time inverse-difference method, even if the speed of sound c is unknown, still the flow speed v of the fluid can be calculated. In this way, the present disclosure should be understood to include a variety of examples, and the like, not set forth herein.

What is claimed is:

1. An ultrasonic integrating calorimeter comprising:
a supply side temperature detector detecting a supply side temperature of a fluid on a supply side of a heat exchanging circuit;
a return side temperature detector detecting a return side temperature of the fluid on a return side of the heat exchanging circuit;
a flow rate measuring portion comprising:
a flow rate measuring pipe wherein flows a return side fluid of the heat exchanging circuit;
a first ultrasonic transducer injecting a first ultrasonic signal into the flow rate measuring pipe; and
a second ultrasonic transducer, disposed at a position able to receive the first ultrasonic signal, injecting a second ultrasonic signal into the flow rate measuring pipe;
a calorific value calculator, secured to the flow rate measuring portion, calculating a calorific value for the heat exchanged by the heat exchanging circuit, based on outputs of the supply side temperature detector, the return side temperature detector, and the flow rate measuring portion;
a calculation signal line transmitting, from the flow rate measuring portion to the calorific value calculator, an output signal of the flow rate measuring portion;
a display, which is at least one of attached or separated from the calorific value calculator, displaying the calorific value; and
a display signal line transmitting, from the calorific value calculator to the display, an output signal of the calorific value calculator;
wherein:
the calculation signal line is shorter than the display signal line.

2. The ultrasonic integrating calorimeter as set forth in claim 1, wherein:
the calorific value calculator is secured to the flow rate measuring pipe.

3. The ultrasonic integrating calorimeter as set forth in claim 1, further comprising:
a dummy signal transmitter, secured to the flow rate measuring portion, transmitting a dummy signal for the calorific value to the display, wherein:
the display signal line connects the calorific value calculator and the dummy signal transmitter to the display.

4. The ultrasonic integrating calorimeter as set forth in claim 3, wherein:
the dummy signal transmitter generates the dummy signal independently from the calorific value calculator.

5. The ultrasonic integrating calorimeter as set forth in claim 3, further comprising:
a testing portion displaying the dummy signal on the display, to test whether or not the dummy signal displayed on the display is affected by noise, when the calorific value displayed on the display is affected by noise.

6. The ultrasonic integrating calorimeter as set forth in claim 5, wherein:
the testing portion determines that the display signal line is affected by noise if the dummy signal, displayed on the displaying portion, is affected by noise.

7. The ultrasonic integrating calorimeter as set forth in claim 5, wherein:
the testing portion determines that the flow rate measuring portion is affected by noise if the dummy signal displayed on the display is not affected by noise.

8. The ultrasonic integrating calorimeter as set forth in claim 5, wherein:
the testing portion determines that the calorific value calculator is affected by noise if the dummy signal displayed on the display is not affected by noise.

9. The ultrasonic integrating calorimeter as set forth in claim 5, wherein:
the testing portion determines that the calculation signal line is affected by noise if the dummy signal displayed on the display is not affected by noise.

10. The ultrasonic integrating calorimeter as set forth in claim 1, wherein:
the fluid flow rate is measured based on a time difference between a first time, for the first ultrasonic signal to arrive at the second ultrasonic transducer through an interior of the measuring pipe, and a second time, for the second ultrasonic signal to arrive at the first ultrasonic transducer through the interior of the measuring pipe, and the return side temperature.

11. The ultrasonic integrating calorimeter as set forth in claim 10, wherein:
the return side temperature is used in correcting the fluid flow rate that is calculated based on the first time and the second time.

12. The ultrasonic integrating calorimeter as set forth in claim 1, wherein:
the flow rate measuring portion is disposed in a space over a ceiling and the display is disposed within a room.

13. The ultrasonic integrating calorimeter as set forth in claim 1, wherein:
the heat exchanging circuit is included in a fan coil unit.

14. The ultrasonic integrating calorimeter as set forth in claim 1, wherein:
the return side temperature detector detects a return side temperature of the fluid within the flow rate measuring pipe.

15. The ultrasonic integrating calorimeter as set forth in claim 1, wherein:
the return side temperature detector detects a return side temperature of a fluid within a return pipe connected to the flow rate measuring pipe.
